(19) United States
(12) Patent Application Publication
(10) Pub. No.: US 2013/0034118 A1
(43) Pub. Date: Feb. 7, 2013

(54) GAS PURIFIER FOR AN EXCIMER LASER

(71) Applicants: Igor Bragin, Gottingen (DE); Oleg Melnikov, Gottingen (DE); Timur Misyuraev, Gottingen (DE); Andreas Targsdorf, Gottingen (DE); Kai Schmidt, Leinefelde (DE)

(72) Inventors: Igor Bragin, Gottingen (DE); Oleg Melnikov, Gottingen (DE); Timur Misyuraev, Gottingen (DE); Andreas Targsdorf, Gottingen (DE); Kai Schmidt, Leinefelde (DE)

(73) Assignee: Coherent GmbH, Gottingen (DE)

(21) Appl. No.: 13/198,484

(22) Filed: Aug. 4, 2011

(51) Int. Cl. H01S 3/22

(52) U.S. Cl. 372/59

(57) ABSTRACT

An excimer laser includes a laser housing containing a lasing-gas mixture including a halogen. Contaminants including particulate matter and a metal halide vapor are generated in the lasing-gas mixture during operation of the laser. A gas-cleaning arrangement extracts lasing-gas mixture from the housing and passes the lasing-gas mixture through an electrode assembly. A repeatedly pulsed gas discharge is created in the electrode assembly by driving the electrode assembly with repeated high-power short-duration pulses. The pulsed discharge causes disintegration of the metal halide vapor and electrostatic trapping in the electrode assembly of the particulate matter and products of the metal halide disintegration.

### TECHNICAL FIELD OF THE INVENTION

The present invention relates in general to excimer lasers. The invention relates in particular to apparatus and methods for reducing degradation or contamination of components of such lasers.

### DISCUSSION OF BACKGROUND ART

Excimer lasers are a class of lasers which generate high-power, pulsed laser-radiation in the ultraviolet (UV) region of the electromagnetic spectrum. They are used extensively for photolithographic operations in semiconductor device manufacture, and for silicon crystallization operations in flat-panel display manufacture. The lasers typically include a housing (pressure vessel) containing a lasing-gas mixture including a chemically aggressive halogen gas, typically chlorine or fluorine, and a heavy noble gas such as argon, krypton, or xenon. The gas mixture is at a pressure in excess of one atmosphere (1.0 Bar) typically between about 3.5 and about 7.0 Bar. A molecular fluorine (F₂) laser is often included in the class of excimer lasers, here however, the gas mixture does not include a heavy inert gas.

Within the laser enclosure are parallel spaced-apart electrodes. That part of the gas mixture between the electrodes is energized by high-voltage, short-duration electrical pulses, applied to the electrodes. The pulses have a very high peak-current, for example greater than about 9000 amperes (A). Each of these pulses create an electrical discharge of correspondingly short duration. During the discharge, the noble gas and the halogen gas form an unstable compound, for example xenon chloride (XeCl) or argon fluoride (ArF), usually referred to as an excimer, which can only exist with one atom thereof electrically excited. When the atom is no longer excited, the compound disintegrates and the excitation-energy is given up as UV radiation.

The laser pressure vessel is often referred to by practitioners of the art as “the laser tube.” The laser tube has a UV-transparent window at each end thereof. Mirrors outside of the laser tube form a laser-resonator. The resonator has a resonator-axis extending through the tube, between the discharge electrodes, via the windows.

The high peak electrical current during a discharge pulse coupled with the chemically aggressive halogen in the gas mixture, leads to erosion of the metal electrodes, and to simultaneous production of significant amounts of dust and gaseous contaminants, particularly volatile metal-halides. A usual method of removing the dust and contaminants involves, in a closed loop filter system, extracting gas from the laser tube; passing the extracted gas through a gas-cleaning device and returning “cleaned” gas back into the tube to replace the contaminated gas extracted.

Such cleaning systems are never 100% effective, and the dust and contamination can only be partially removed during a gas replacement. Because of this there is some residual dust and contamination which accumulates over time with operation of the excimer laser. This accumulation causes the gradual degradation of the laser performance and, in particular, gradual reduction of the transmission of the windows of the laser tube. Eventually it becomes necessary to replace the laser tube, or to replace windows in a laser-tube, in a major maintenance operation on the laser.

Typical gas cleaning systems include one or more dust-removal elements such as a mesh filter, a gravitational filter, or an electrostatic filter. These are often used in conjunction with a cryogenic trap for condensing volatile (gaseous) contaminants (vapors).

Of the dust removal elements, an electrostatic device is particularly preferred. Such a device typically includes a metal tube or cylinder, providing one electrode of an electrode-pair, with metal wire along the cylindrical axis of the tube providing the other electrode of the electrode-pair. The axial-wire electrode is at a high negative potential with the cylindrical electrode grounded. A CW gas-discharge is set up between the electrodes. This causes dust particles to become electrically charged and electrostatically attracted to the cylinder by the electric field between the axial and cylindrical electrodes. This type of electrostatic filter is not effective for removing gaseous contaminants.

The use of such electrostatic filters for excimer laser gas-cleaning has been found to have certain shortcomings. In particular, electrical discharge in the laser gas mixtures is essentially unstable. This is because of the very high gas pressure and the strongly electronegative species (halogen in particular) content of the mixture. In the laser itself, the high-power laser discharge is reproducible only during the relatively short duration of the discharge pulses, typically less than 200 nanosecond (ns), and this duration is limited by the development of arcs.

A CW discharge, used for the above-described electrostatic dust filter is only possible at very low electrical current and power level, and is also limited by the development of arcing. The occurrence of arcing not only limits the effectiveness of the filter but also leads to significant additional contamination of the laser gas, and consequently the laser-tube windows.

By way of example, in one example of such an electrostatic filter, the maximum input current did not exceeded 0.4 milliamperes (mA) at a high-voltage level of 1.5 kilovolts kV, a power of only 0.6 Watts (W). Nevertheless, there was still a strong tendency to arcing, and long term operation was limited. A current sufficiently low to allow long-term arc-free operation of the electrostatic filter is not sufficient to provide a desirable level of dust-filtering. There is a need to overcome this shortcoming of electrostatic filters.

### SUMMARY OF THE INVENTION

In one aspect, laser apparatus in accordance with the present invention comprises a laser housing containing a lasing-gas mixture including a halogen gas and at least one gas-cleaning arrangement. The gas-cleaning arrangement is configured to extract lasing-gas mixture from the laser housing, pass the extracted lasing-gas mixture gas through an electrode assembly, and to create a high-voltage, repeatedly pulsed discharge in the lasing-gas mixture in the electrode assembly for cleaning the lasing-gas mixture passing therethrough.

The lasing-gas mixture extracted from the housing contains contaminants including particulate matter and at least one metal halide vapor. The pulsed discharge causes disintegration of the metal halide vapor and electrostatic trapping in the electrode assembly of the particulate matter and products of the metal halide disintegration.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1 is a plan view from above, partly in cross-section, schematically illustrating a preferred embodiment of an excimer laser in accordance with the present invention including a laser housing containing a lasing-gas mixture and two electrostatic gas-cleaners driven by a pulsed high-voltage power-supply, with the gas-cleaners arranged to extract lasing-gas mixture from the housing, clean the lasing gas, and return the cleaned lasing-gas mixture to the housing.

FIG. 2 is a fragmentary cross-section view schematically illustrating details of an electrode assembly in a gas cleaner of the apparatus of FIG. 1.

FIG. 3 is a reproduction of an oscilloscope trace schematically illustrating a high-voltage pulse and a corresponding high-current pulse applied to the electrode assembly in an example of the gas cleaner of FIG. 2.

### DETAILED DESCRIPTION OF THE INVENTION

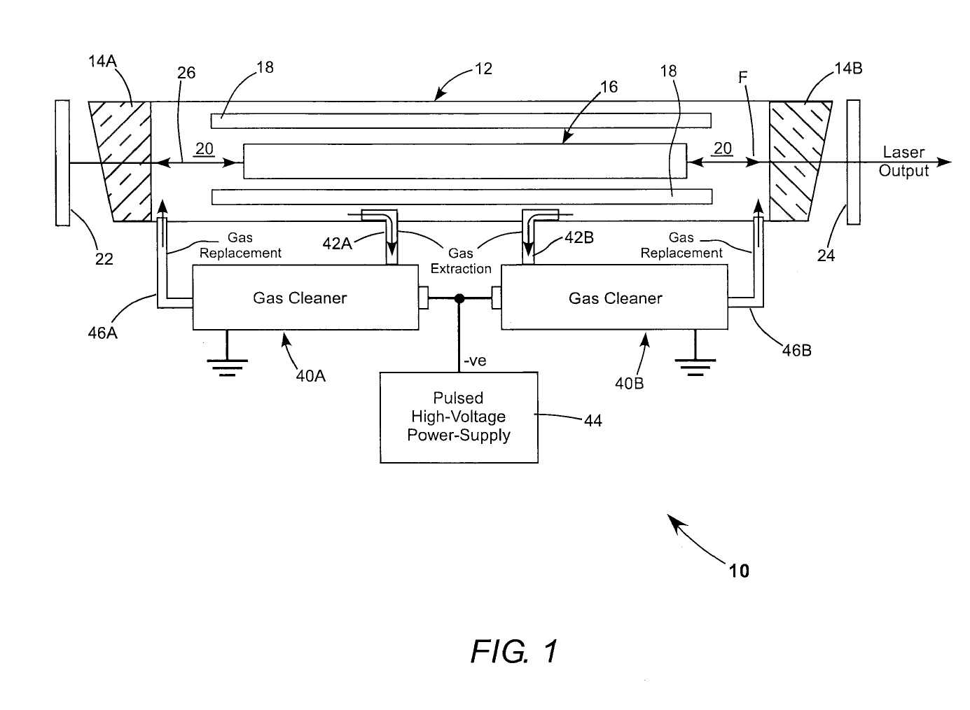

Referring now to the drawings, wherein like components are designated by like reference numerals, FIG. 1 schematically illustrates a preferred embodiment 10 of excimer-laser apparatus in accordance with the present invention. Apparatus 10 includes an elongated laser housing 12 having UV-transparent windows 14A and 14B at opposite ends thereof. In practical excimer-laser arrangements the laser housing can be an aluminum tube and the windows can be removably sealed to the tube using elastomer O-ring seals or the like.

A lasing-gas mixture is contained within the laser housing. The lasing-gas mixture includes at a halogen gas, typically chlorine or fluorine. In a true excimer laser the lasing-gas mixture also includes a heavy noble gas selected from the group of noble gases consisting of argon, krypton, and xenon. In a molecular fluorine laser, the heavy noble gas is omitted from the mixture. The remainder of the lasing-gas mixture, providing the majority constituent, typically includes a light inert gas such as helium or neon. The lasing-gas mixture is at a super-atmospheric pressure well excess of about 1.5 Bar and preferably between about 3.5 bar and about 7.0 Bar. Within the enclosure is a pair 16 of spaced-apart elongated discharge electrodes, only a top one of which is visible in FIG. 1. High-voltage short-duration electrical pulses applied to the electrodes energize lasing-gas mixture therebetween to provide optical gain via the excimer-disintegration mechanism described above. Pre-ionizers 18 are provided for stabilizing a lasing discharge between the electrodes. A laser-resonator 20 is formed between a maximally reflective mirror 22, and a partially reflective and partially transmissive output-coupling mirror 24. The laser-resonator has a longitudinal resonator axis 26 extending through windows 14A and 14B, and between electrode pair 16. Fundamental laser-radiation, generated in response to discharge pulses, circulates along axis 26 as indicated by arrows F. Laser-radiation pulses are output from resonator 20 via output-coupling mirror 24.

As noted above, during operation of an excimer laser, the lasing-gas mixture in the housing becomes contaminated with particulate matter and vapors generated as a result of erosion of electrodes and support and other structures in the housing. In a prior-art xenon chloride (XeCl) laser (gas mixture including xenon and chlorine) the windows in the laser housing were analyzed to identify such contaminants. It was found the contaminants included condensed tungsten (W) and copper (Cu) chlorides. These are believed to have their origin in erosion of discharge and pre-ionizer electrodes by the lasing-gas mixture. Contaminants also included metallic aluminum (Al), which is believed to have been produced by erosion of aluminum of the housing and internal support structures for electrodes and the like; various hydrocarbons believed to originate from out-gassing of elastomer window-seals; and iron (Fe) chloride believed to originate from erosion of baffles provided to protect, to some extent, the housing windows.

In apparatus 10, two-gas cleaning modules, 40A and 40B, essentially identically configured, are provided for removing above-described and similar contaminants from the lasing-gas mixture in the laser-housing. Each module is arranged to continually receive lasing-gas mixture, using an internal cross-tangential blower (not shown) within the laser tube, from the housing via a conduit 42 (A or B) positioned near the center of the housing. The extracted gas is passed through an electrode assembly (not shown in FIG. 1). The electrode assembly is driven by repeated high-voltage short-duration pulses provided by a high-voltage pulsed power supply 44. This creates a repeated, pulsed corona discharge in the gas in the electrode assembly for cleaning the lasing gas. The cleaned laser gas is then returned to the laser housing, via conduits 46A and 46B. Preferably, the high-voltage pulses are negative-going pulses.

Power supply 44 includes a fast switching modulator of some known kind. Such a modulator typically includes a storage capacitor, which is charged and subsequently discharged to provide a voltage pulse; a high voltage power supply to charge the storage capacitor between pulses; and an electrical switching element or elements for switching the discharging of the storage capacitor. Shaping the pulse can be effected by additional elements such as resistors, capacitors, inductors (including nonlinear inductors), and pulse-transformers. The switching element can include any kind of fast high-voltage commutators such as thyristors, MOSFETs, IGBTs and thyratrons.

The applied voltage pulses preferably have a peak (negative) voltage greater than about minus 2 kilovolts (KV). The duration of the voltage pulses is preferably less than about 400 ns, and more preferably less than about 200 ns. A preferred pulse repetition rate for pulse delivery is between about 5 kilohertz (KHz) and about 25 KHz, and more preferably between about 10 KHz and about 15 KHz.

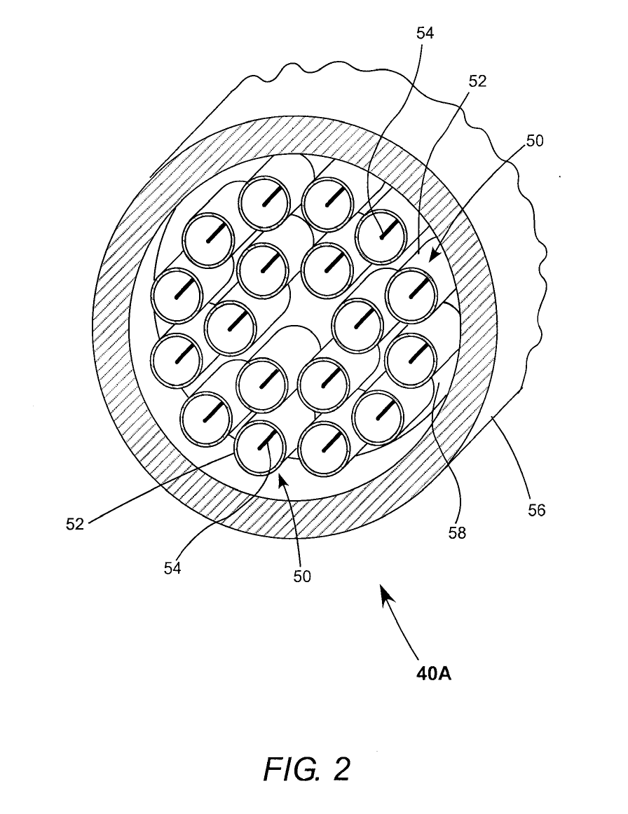

FIG. 2 is a fragmentary cross-section view schematically illustrating details of a preferred arrangement of gas-cleaning module 40A in the apparatus of FIG. 1. The module includes a plurality electrode pairs 50, with each pair, here, including a tube or cylinder electrode 52 having a central wire or rod electrode 54 extending along the cylindrical axis of the tubular electrode. The electrode pairs are held parallel to each other in a cylindrical housing 56 by support members 58 (only one visible in FIG. 2). Preferably the negative potential of power supply 44 is applied to the central electrodes 54, with electrode 52 grounded. Electrodes 54 are electrically connected together at one end of the housing and the common connection electrically connected to power supply 44. Cylindrical electrodes 52 can be connected to a common ground via support members 58 and housing 56.

High-voltage pulses supplied by power supply 44 are sufficient to cause a corresponding pulsed corona discharge in each electrode pair 50. Charged particulate matter and ionized gaseous species are caused to drift toward, and be captured on, electrodes 52. This particular arrangement of electrode-pairs provides for a large capture area with minimum resistance to gas flow through the gas cleaning modules.

In an experimental evaluation of the present invention, a XeCl excimer laser was fitted with inventive cleaning modules configured as above-described. It was found that the repetitive application of the short high-voltage pulses of negative polarity provided arc-free operation of the cleaning modules with a significantly higher cleaning efficiency than that of prior-art CW electrostatic gas cleaners. In the experiment, the applied pulses had a peak-amplitude between about 2.5 KV and 3.6 KV.

The pulses had a FWHM duration less than about 400 ns with a fall-time less than about 50 ns. The repetition frequency of the pulses was varied in a range between about 8 KHz and about 25 KHz. The average electrical power consumed by the device was about 20W, at an average electrical current about 14 mA.

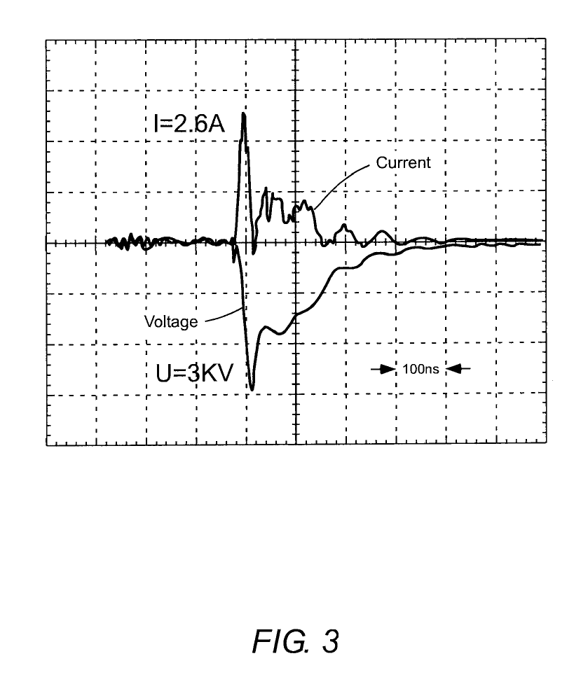

FIG. 3 is a reproduction of an oscilloscope-trace schematically illustrating a measured high-voltage pulse and a corresponding high-current pulse in the above-described experiment. It can be seen that the peak-voltage is about −3.0 KV with a corresponding peak current of about 26 A. The FWHM duration of the voltage pulse is about 150 ns.

The interior of one of the inventive gas-cleaning modules was inspected after extended operation of the laser for about 5000 Hours. A substantial amount of solid contaminants were found at the output end of the module where the cleaned gas leaves the electrode-pairs. The amount found significantly exceeded the amount of the solid contaminants in the entrance area of purifier. This indicates that the solid contaminants at the output end were produced by decomposition of gaseous impurities in the active corona discharge area of the electrode pairs. In essence, the electrode pairs were effectively operating as a plasma chemical reactor, decomposing heavy gaseous contaminants including metal halide vapors to form solid contaminants which could be easily collected on the cylindrical electrodes in the electrode-pair assembly. These gaseous contaminants have been found difficult to remove (at least completely), by any means, in prior-art gas cleaners. Comparative tests of complete laser tubes have shown a reduction of contamination on the window surface of more the factor 3 was using the inventive gas cleaning arrangement compared with contamination produced using a prior-art DC gas cleaning arrangement.

In conclusion, the present invention is directed to a gas-cleaning arrangement for the lasing-gas mixture in an excimer laser. The gas-cleaning arrangement includes an electrode assembly in which a pulsed gas-discharge is formed in lasing-gas mixture extracted from the laser. The inventive cleaning arrangement is effective in trapping particulate matter in the extracted lasing-gas mixture and also in disintegrating gaseous contaminants including metal halide vapor. Those skilled in the art will recognize that other configurations of the pulsed-discharge electrode assembly are possible and that the pulsed-discharge arrangement may be used alone or in cooperation with prior-art cleaning elements such as mechanical filters, DC electrostatic precipitators, or cryogenic traps, all without departing from the spirit and scope of the present invention. In addition, while the illustrated configuration of extracting the gas from the central region of the tube and injecting the cleaned gas back into the tube near the windows is preferred, other arrangements are possible.

The inventive gas-cleaning arrangement is described above in terms of a preferred embodiment. The invention, however, is not limited to the embodiment described and depicted. Rather, the invention is defined by the claims appended hereto.

What is claimed is:

1. Laser apparatus, comprising:
a laser housing containing a lasing-gas mixture including a halogen gas;
at least one gas-cleaning arrangement configured to extract the lasing-gas mixture from the laser housing and return cleaned gas back to the housing, said gas cleaning arrangement including an electrode assembly; and
a power supply for supplying the electrode assembly with repeated voltage pulses to create a pulsed discharge in the lasing-gas mixture for cleaning the lasing-gas mixture.

2. The apparatus of claim 1, wherein the lasing-gas mixture extracted from the housing contains contaminants including particulate matter and at least one metal halide vapor, and wherein the pulsed discharge causes disintegration of the metal halide vapor and electrostatic trapping in the electrode assembly of the particulate matter and solid products of the metal halide disintegration.

3. The apparatus of claim 2, wherein the metal halide vapor is one of a tungsten halide, a copper halide and an iron halide.

4. The apparatus of claim 1, wherein the halogen in the lasing-gas mixture is one of chlorine and fluorine.

5. The apparatus of claim 1, wherein the lasing-gas mixture further includes one of argon, krypton, and xenon.

6. The apparatus of claim 5, wherein the lasing-gas mixture additionally includes one of helium and neon.

7. The apparatus of claim 1, wherein the lasing-gas mixture is at a pressure greater than atmospheric pressure.

8. The apparatus of claim 7, wherein the lasing-gas mixture is at a pressure between about 3.5 Bar and about 7 Bar.

9. The apparatus of claim 1, wherein the pulsed discharge is created by applying to the electrode assembly negative-going electrical pulses having a peak voltage greater than about 2 kilovolts and a FWHM duration less than about 400 nanoseconds at a pulse-repetition frequency between about 5 kilohertz and about 25 kilohertz.

10. The apparatus of claim 9, wherein the electrical pulses have a duration less than 200 nanoseconds at a pulse-repetition frequency between about 10 kilohertz and 25 kilohertz.

11. The apparatus of claim 1 wherein the peak voltage applied to the electrode assembly is at least 2 kilovolts.

12. The apparatus of claim 1 wherein the electrode assembly includes a plurality of electrode pairs, each pair including a cylindrical ground electrode and a central wire electrode.

13. Laser apparatus, comprising:
a laser housing containing a lasing-gas mixture including one of chlorine and fluorine;
at least one gas-cleaning arrangement configured to extract the lasing-gas mixture from the laser housing, pass the extracted lasing-gas mixture through an electrode assembly and return the clean gas back to the housing;
a power supply for supplying the electrode assembly with repeated voltage pulses to create a pulsed discharge in the lasing-gas mixture for cleaning the lasing-gas mixture passing therethrough, wherein the lasing-gas mixture extracted from the housing contains contaminants including particulate matter and one of a metal chloride vapor and a metal fluoride vapor, and wherein the pulsed discharge causes disintegration of the metal chloride or fluoride vapor and electrostatic trapping in the electrode assembly of the particulate matter and solid products of the metal chloride or fluoride disintegration.

14. The apparatus of claim 13, wherein the metal component of the chloride or halide vapor is one of tungsten, copper, or iron

15. The apparatus of claim 14, wherein the lasing-gas mixture is at a pressure greater than atmospheric pressure.

16. The apparatus of claim 15, wherein the lasing-gas mixture is at a pressure between about 3.5 Bar and about 7 Bar.

17. The apparatus of claim 16, wherein the pulsed discharge is created by applying to the electrode assembly negative-going electrical pulses having a peak voltage greater than about 2 kilovolts and a FWHM duration less than about 400 nanoseconds at a pulse-repetition frequency between about 5 kilohertz and about 25 kilohertz.

18. The apparatus of claim 17, wherein the electrical pulses have a duration less than 200 nanoseconds at a pulse-repetition frequency between about 10 kilohertz and 25 kilohertz.

19. The apparatus of claim 13 wherein the peak voltage applied to the electrode assembly is at least 2 kilovolts.

20. The apparatus of claim 13 wherein the electrode assembly includes a plurality of electrode pairs, each pair including a cylindrical ground electrode and a central wire electrode.

21. A method of operating a gas laser, said gas laser having a housing holding a lasing gas mixture, said gas laser including a gas recirculation loop for extracting gas from the housing, cleaning the gas and returning to the cleaned gas to the housing, said loop including a chamber having electrode pairs therein, said method comprising the step of:
supplying the electrode pairs with repeated voltage pulses, said pulses having a peak voltage of at least 2 kilovolts and a repetition frequency of at least 5 kilohertz/

22. A method as recited in claim 21 wherein the FWHM duration of the pulses is less than 400 nanoseconds.

23. A method as recited in claim 21 wherein the FWHM duration of the pulses is less than 200 nanoseconds and the pulse repetition frequency is between 10 kilohertz and 25 kilohertz.
